(19) United States
(12) Patent Application Publication
(10) Pub. No.: US 2024/0327751 A1
(43) Pub. Date: Oct. 3, 2024

(54) Eco-Friendly DIY Candle Making Kits For Filling Or Refilling New Or Used Candle Vessels

(71) Applicant: Christine Martindale, Truckee, CA (US)

(72) Inventor: Christine Martindale, Truckee, CA (US)

(21) Appl. No.: 18/129,013

(22) Filed: Mar. 30, 2023

(51) Int. Cl. C11C 5/02; C11C 5/00

(52) U.S. Cl. CPC C11C 5/023; C11C 5/006

(57) ABSTRACT

Kits and methods are provided for filling or refilling new or used candle vessels. The kits and methods are designed to offer a viable, convenient, easy-to-use, and environmentally conscious product and/or option for consumers to reuse, repurpose, fill or refill new or existing candle vessels. A candle making kit apparatus includes a wax assembly having a refill wax stored in a recyclable container, and a materials assembly including one or more materials for use with the refill wax. The kits can be made with eco-friendly and recycled materials and, after use, the kits can be recycled or reused to lessen the burden of our landfills and on our environment.

### SUMMARY OF THE INVENTION

The present invention is generally related to candles and candle making, and more specifically related to kits that allow a user to recycle a previously used candle vessel by preparing and pouring newly melted candle wax into an empty candle vessel. While the present invention is intended to be eco-friendly through the use of eco-friendly, biodegradable and/or recyclable materials, the herein disclosed kits and methods and can be formed of any material and still remain eco-friendly because the kit and methods allow for the reuse or recycling of previously used and/or discarded candle vessels without the need to manufacture new candle vessels. A user is also able to make an entirely new candle by using the herein disclosed kit and method with a new candle vessel.

There herein disclosed kits and methods are designed to offer a viable, convenient, easy-to-use, and environmentally conscious product and/or option for consumers to reuse, repurpose, fill or refill new or existing candle vessels. As more fully explained herein, the kits can be made with eco-friendly and recycled materials and, after use, the kits can be recycled or reused to lessen the burden of our landfills and on our environment. The herein disclosed kits and methods can be considered environmental considerate DIY (do-it-yourself) creative projects, so that users of all ages are able to enhance their positivity and wellness while doing so in a environmentally conscious manner that they can feel good about.

In a preferred embodiment, the herein disclosed candle making kit apparatus includes a wax assembly having a refill wax stored in a recyclable container, and a materials assembly including one or more materials for use with the refill wax. The recyclable container is heated so that the refill wax may be poured into a candle vessel and combined with one or more materials from the materials assembly to form a candle. The one or more materials may, for example, include one or more wick assemblies, a stir stick, and a set of instructions.

The present invention may also be described as a method for facilitating the use of a candle vessel. Preferably, the method for facilitating the use of a candle vessel involves the following steps: providing a candle making kit apparatus including a wax assembly having a refill wax stored in a recyclable container and a materials assembly having one or more materials for use with the refill wax including one or more wick assemblies and instructions for instructing a user; instructing the user to prepare a candle vessel to receive refill wax from the wax assembly; instructing the user to set one or more wicks assemblies within the candle vessel, including removing one or more adhesive covers from the one or more wick assemblies and attaching the one or more wick assemblies to the candle vessel via the one or more wick adhesives; instructing the user to heat the refill wax; instructing the user to pour the refill wax into the candle vessel; instructing the user to allow the refill wax to sit, set, and cure before burning; and instructing the user to trim one or more wicks of the one or more wick assemblies, after the refill wax has sat, set, and cured.

### CROSS-REFERENCES TO RELATED APPLICATIONS

This non-provisional utility application takes priority to the previously filed provisional application: Application No. 63/325,209 by inventor Christine Martindale, filed Mar. 30, 2022, which is hereby incorporated in its entirety by reference.

### BACKGROUND OF THE INVENTION

Candles are popular home items used everyday throughout the world to calm nerves and create soothing and comforting environments. Many people who use candles are environmentally conscious and would prefer to lessen their impact on the nature world by avoiding unnecessary consumption of goods and unnecessary accumulation of single use items in another landfill. But when candles are fully burned, or when a user tires of the scent of a particular candle, usually the entire candle is discarded and yet another single-use items piles up in our landfills. It would therefore be advantageous to provide a product and/or a methodology for reusing candle vessels so that environmentally conscious persons can refill candle vessels efficiently and therefore environmentally conscious persons can enjoy fresh candle scents without throwing away old or used candle vessels.

### BRIEF DESCRIPTION OF THE SEVERAL VIEWS OF THE DRAWING

FIG. 1 illustrates a general overview of the herein candle making kit apparatus, in accordance with an exemplary embodiment of the present invention;

FIG. 2 illustrates a one or more steps of a method for facilitating a use of a candle vessel, showing a user using a cutting instrument to cut a wick, in accordance with an exemplary embodiment of the present invention;

FIG. 3 illustrates a one or more steps of a method for facilitating a use of a candle vessel, showing a wick adhesive component of a wick assembly, in accordance with an exemplary embodiment of the present invention;

FIG. 4 illustrates a one or more steps of a method for facilitating a use of a candle vessel, showing a first wick assembly, a second wick assembly, and a third wick assembly set throughout a candle vessel and melted wax being poured into the candle vessel, in accordance with an exemplary embodiment of the present invention;

FIG. 5 illustrates a one or more steps of a method for facilitating a use of a candle vessel, showing wax set within a candle vessel and a wick being trimmed, in accordance with an exemplary embodiment of the present invention;

FIG. 6 illustrates a completed candle vessel having newly filled wax that has sat, set, and cured and a plurality of wick assemblies that have been set within the candle vessel and trimmed, in accordance with an exemplary embodiment of the present invention; and

FIG. 7 illustrates a general overview of a method of facilitating a use of a candle vessel, in accordance with an exemplary embodiment of the present invention.

### DETAILED DESCRIPTION OF THE INVENTION

The present invention is generally related to candles and candle making, and more specifically related to kits that allow a user to recycle a previously used candle vessel by preparing and pouring newly melted candle wax into an empty candle vessel. The herein disclosed candle making kit, including apparatus and methods, is inherently eco-friendly because the kit facilitates a user to recycle previously used candle vessels and therefore avoid waste and avoid unnecessary manufacturing of new candle vessels. The herein disclosed apparatus and methods can be made even more eco-friendly by forming a materials bag of eco-friendly materials and/or fully recyclable materials.

Throughout this specification, reference will be made to candle wax that is to be heated and then poured into a candle vessel. The wax will mostly be referred to as refill wax because a primary benefit of the herein disclosed apparatus and methods is to allow a user to recycle a previously used candle vessel by refilling the candle vessel with one or more new wicks and new candle wax. But it will be apparent that the herein disclosed apparatus and methods will also provide an ability to make a candle with any candle vessel, regardless of whether the candle vessel has previously held wax or the candle vessel is new or was not previously used as a candle vessel. Therefore, the phrase refill wax is intended to include all situations including wherein the wax is new wax and/or the candle vessel is new or has never previously been used as a candle. Likewise, the phrase candle vessel is intended to include both new candle vessels and candle vessels that previously held different wax and therefore may be considered used candle vessels.

Referring to FIG. 1, a candle making kit apparatus is shown comprising wax assembly 100 and materials assembly 200. Candle vessel 1 and cutting instrument 2 are also shown; candle vessel 1 and cutting instrument 2 are, in a preferred embodiment, not included in a candle making kit apparatus and instead are generally items that a user would have at home or would acquire separately. Candle vessel 1 may be used or new, and may be any shape appropriate for holding candle wax and allowing the candle wax to sit, set, and cure. As illustrated in the various figures, candle vessel 1 may be elongated in shape with a relatively shallow depth. But there herein disclosed apparatus and methods may be utilized with a candle vessel of any shape or size and the shape and size of the candle vessel in the figures is only provided as an example. As an alternative example, candle vessel may have a more cylindrical shape and have a deeper depth, such as a standard round candle shape.

In an exemplary embodiment, wax assembly 100 includes refill wax 110 stored in recyclable container 120. Preferably, recyclable container 120 includes removable lid 130 which is also formed of a recyclable material. Refill wax 110 is intended to be heated and so recyclable container 120 is formed of a material that is microwave safe or oven safe, or both microwave safe and oven safe. As discussed herein, refill wax 110 can be any wax that may be formed into a candle and burned or melted via an embedded wick. The wax of refill wax 110 may be new wax or reclaimed/recycled wax, and may include one or more additives such as oil or fragrances.

In the exemplary embodiment as illustrated in FIG. 1, materials assembly 200 may include one or more of the following items: a set of one or more wick assemblies 210, stir stick 240, instructions 230. Alternative embodiments of the present invention may include one or more additional items in materials assembly 200. For example, one or more additives may be included in materials assembly 200, such as one or more oils, fragrances, herbs, flowers, etc. In such an alternative embodiment, a user may be instructed to add one or more additives to refill wax 110 when refill wax 110 has been heated and then further instructed to combine the one or more additives to the refill wax by using stir stick 240 to mix the combination within recyclable container 120 before pouring refill wax 110 into candle vessel 1.

Wick assemblies 210 may include one or more wick assemblies depending on what type or size candle vessel is being used. As illustrated in the drawing figures, an exemplary embodiment may include three wick assemblies, but alternative examples may utilize one wick assembly, two wick assemblies, or more than three wick assemblies. Regardless of how may wick assemblies are included or utilized, each wick assembly includes a wick anchored to a wick adhesive. As illustrated in FIG. 1, wick assemblies 210 may include a first wick assembly having first wick 211 anchored to first wick adhesive 221, second wick assembly having second wick 212 anchored to second wick adhesive 222, and third wick assembly having third wick 213 anchored to third wick adhesive 223. Each wick is any candle wick formed of a relatively slow burning material that advantageously burns or melts candle wax. Each wick adhesive is a base attached to the wick that allows the wick to be attached to a surface of candle vessel 1. In a preferred embodiment, each wick adhesive (components 221, 222, and 223 in the drawing figures) includes an adhesive surface covered with a removeable wick adhesive cover. To set the wick assembly in the candle vessel, a user first removes the wick adhesive cover and then places the adhesive surface flat onto the candle vessel. The adhesive surface sticks to the candle vessel and thereby sets the wick in place in the candle vessel. In an alternative embodiment, a wick adhesive may instead include a flat surface that is intended to receive a binding substance. In this example, a user would apply a binding substance, such as glue, directly onto the flat surface before placing this flat surface onto the candle vessel; the binding substance holds the wick adhesive in place and thereby sets the wick in place in the candle vessel.

Instructions 230 include instructions instructing a user to carry out a series of steps to use the components of the herein disclosed candle making kit apparatus. Instructions 230 may be any type of instructions fixed on any type of medium. For example, instructions 230 may be written instructions printed on a folded piece of paper, as is shown in the various drawing figures as a preferred embodiment. But instructions 230 may alternatively be stored digitally or electronically and may be included in materials assembly 200 as a flash drive or on an alternative electronic format such as on a website that is noted by provided a link or website address for a user to access, for example.

In a preferred embodiment of the present invention, instructions 230 take the form of written instructions and may, for example, include the following specific set of instructions, which may be presented to a user in the following order in order to instruct the user:

“CLEAN: Remove your existing wicks by popping up the underside of the wick tabs with a butter knife and removing any existing adhesive. To remove the remaining soy wax, it can be warmed and melted with a blow dryer or heat gun OR once any metal wicks have been removed, heated in the microwave (if not a metal vessel) or melted via low heat in an oven. Carefully, wipe out the remaining wax a with paper towels and dispose. Make sure the bowl is free from wax before continuing to the next step.”

“SET WICKS: Remove the adhesive from the wick stickers on the bottom of your wicks. Keep in mind that the wicks will burn an area of 2½″-3½″ diameter so set them accordingly. When using multiple wicks make sure to keep them at least 2″ from the edge of your candle vessel. Place and firmly press your wick/stickers firmly to your candle vessel. Once wicks are set, trim wick tops so that they are about 1″ over the top of the vessel that you're pouring.”

“1-Wick—Place in the center of your vessel (example mason jar).”

“2-Wick—Each wick centered and evenly spaced from each other and the edge of your vessel. (Example Tahoe Bowls and Daisy Bojo)”

“3-Wicks-Centered and evenly space from each other and the edge of your vessel. (Example Rustic Hearts and Wood Bowl)”

“4 or More Wicks-Use the above dimensions to divide space of your vessel burning surface. (Example 6-Wick Wood Bowls)”

“HEAT: Remove the lid and place your refill wax container in the microwave on medium low heat for approximately 2 minutes. Carefully stir the melting wax with your wooden stir stick. If wax is not fully melted, heat an additional 30 seconds at a time and stir until wax is completely melted. Let sit until wax starts to cool and it starts to look cloudy. Wait until it's cool enough to touch before you pick it up. You can also use a 200-degree oven (on a lower rack) on a cookie sheet lined with parchment paper which will take about an hour. Make sure to check often and don't leave unattended. When melted, shut off oven and leave oven door ajar to cool. Wait until the wax has started to get cloudy and cooled down before removing.”

“PREPARE: While you are waiting for your wax to cool, prepare the location that your candle vessel will be setting and curing in. You will want to make sure that it's on a level and stable surface away from breezes or strong heat that may affect the setting and curing process. Always keep melting wax away from children, pets, or sensitive areas.”

“POUR: Carefully and slowly pour the melted wax into your candle vessel, making sure to leave a little space at the top so the when the candle is burning it does not leak over the edge. You may now recycle the soy candle wax container and lid.”

“CANDLE TOPS: If you're adding any dried flowers, stones or other candle top décor, you're going to add to your candle top after pouring the wax and before the candle top solidifies. Keep any items added to your candle top on the edge and away from the wicks and burning area. Never leave your candle burning unattended and keep watch that anything added to your candle top is away from the wicks at all times.”

“CURING: As your candle starts to solidify and the wax has cooled down, you can gently straighten the wicks if needed. Make sure not to pull them particularly when the wax is still very warm. Let your candle sit, set, and cure for at least (24) hours before burning.”

“TRIM & BURN: Trim your wicks to ¼″. Make sure that on your first burn, you let the candle melt all the way across the top of your candle which sets an even and long-lasting burn life for your candle.”

“SAFETY: Always burn your candles on a heat resistant surface and keep them away from flammable items, small children, and pets. Keep your candles away from drafts, vents, or ceiling fans to prevent smoking or wick blowing which could cause the candle to burn unevenly. Never touch a burning candle.”

“FIRST BURN: Be sure to let your candle melt ALL THE WAY ACROSS surface top of candle on the first burn. It sets an even tone to the burn process so you can receive the longest experience with your candle.”

“JUST IN CASE: If any spillage occurs, soy wax is biodegradable and cleans up with soap and hot water!”

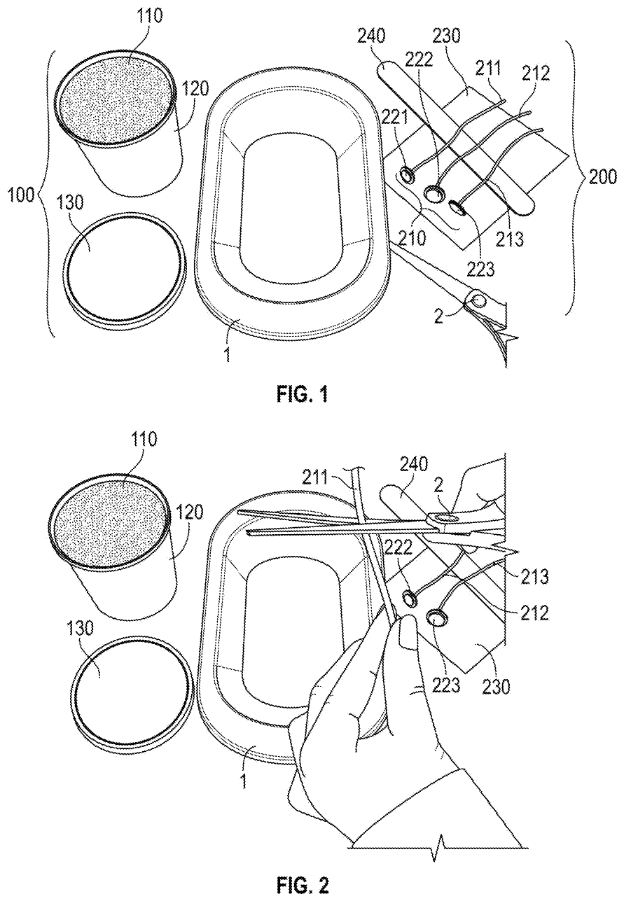

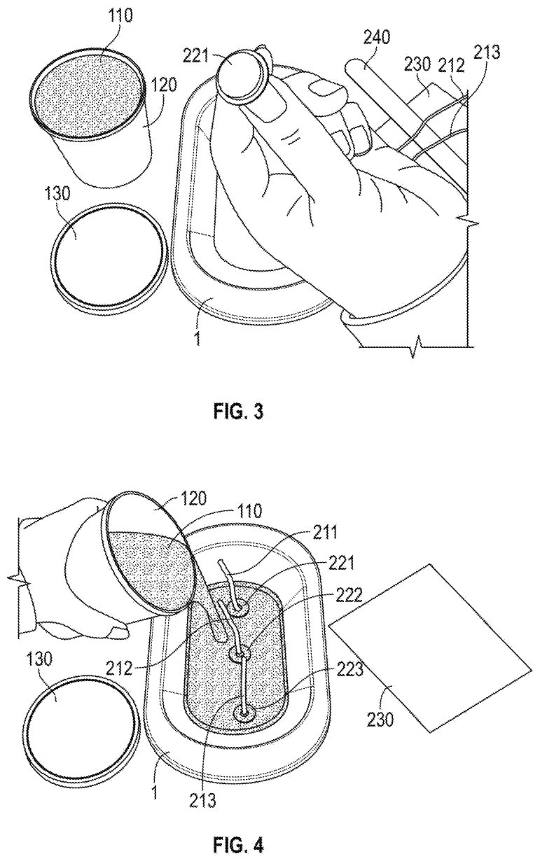

Referring to FIG. 2, a user is shown using cutting instrument 2 to trim wick 211 to a shorter length before placing wick 211 (via wick adhesive 221, which is not visible in FIG. 2) within candle vessel 1. And referring to FIG. 3, the underside of an exemplary wick adhesive (first wick adhesive 221) is shown. Wick adhesive 221 is placed on a flat surface of candle vessel 1; if additional wick assemblies are desired or required for candle vessel 1, then the user is instructed to place additional wick assemblies at approximately equidistance intervals throughout a flat surface of candle vessel 1.

Referring to FIG. 4, it can be seen that first wick 211 is set in candle vessel 1 via first wick adhesive 221, second wick 212 is set in candle vessel 1 via second wick adhesive 222, and third wick 213 is set in candle vessel 1 via third wick adhesive 223. Instructions 230 further instruct a user to heat refill wax 110 within recyclable container 120. Users may be instructed that there are at least two options for heating refill wax 110: to heat refill wax 110 within recyclable container 120 in a microwave or to heat refill wax 110 within recyclable container 120 in a low heat oven (or a standard home oven set to a relatively low temperature). After refill wax 110 is heated and/or cooled as instructed, refill wax 110 is poured into candle vessel 1 so that candle vessel 1 is at least partially filled around one or more wick assemblies.

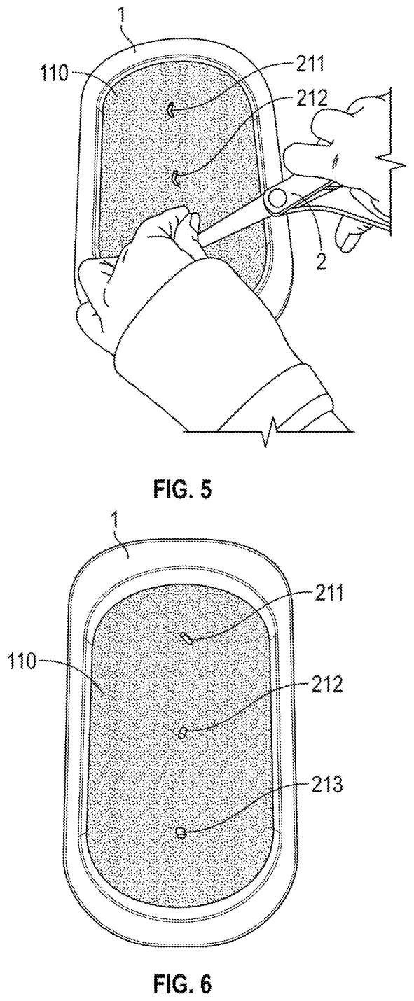

Referring to FIG. 5, instructions 230 instruct a user to allow refill wax 110 to sit, set, and cure within candle vessel 1. This step involves waiting for the refill wax to cool in candle vessel 1. Once set and cured, instructions 230 instruct a user to trim the one or more wicks (illustrated as components 211 and 212 in FIG. 5; wick 213 is not visible but is being trimmed by a user in FIG. 5) to a shorter and useable length, before burning.

Referring to FIG. 6, a completed candle vessel 1 is shown having refill wax 110, first wick 211, second wick 212, and third wick 213.

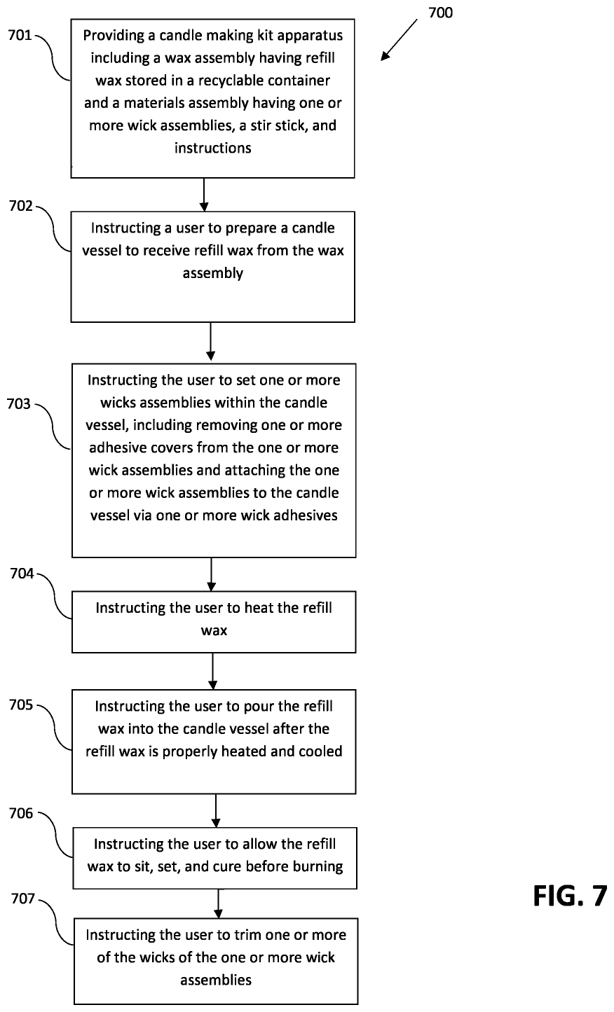

In addition to the herein disclosed candle making kit apparatus, the present invention may be described as one or more methods for facilitating the use of a candle vessel. An exemplary embodiment of such a method is illustrated in FIG. 7 as method 700 for facilitating the use of a candle vessel.

Step 701 of method 700 involves providing a candle making kit apparatus wherein the candle making kit apparatus includes a wax assembly having refill wax stored in a recyclable container and a materials assembly having one or more materials. The one or more materials of the materials assembly may be collectively stored in an eco-friendly bag or container, thus making the entire product and methodology eco-friendly. In a preferred embodiment, the materials assembly includes one or more wick assemblies (wherein each wick assembly includes a wick anchored into a wick adhesive), a reusable stir stick, and instructions for instructing a user how to use the kit. The instructions provide instructions to the user that instruct the user to carry out a series of steps in order to utilize the provided refill wax and materials to fill the candle vessel to form a new or reused candle.

Step 702 of method 700 involves instructing the user to prepare the candle vessel to receive refill wax from the wax assembly. For clean or non-previously used candle vessels, step 702 may only involve placing the candle vessel on a flat surface. But in other circumstances, such as when a previously used candle vessel still retains some wax or one or more wick adhesives (or wick attachments), step 702 may involve instructing the user to pop up undersides of existing wick tabs or wick adhesives with a knife and/or warming and melting existing wax so that the candle vessel is free of wax before continuing to the subsequent steps of method 700.

Step 703 of method 700 involves instructing the user to set one or more wick assemblies within the candle vessel. For example, step 703 may involve removing one or more adhesive covers from one or more wick assemblies and attached the wick assemblies to the candle vessel via the one or more wick adhesives. In certain embodiments wherein the wick assemblies do not include a self-adhesive surface, a user may be instructed to apply a binding substance, such as glue, to a flat surface of the wick assembly and using the binding substance to adhere the wick assembly to a surface of the candle vessel.

Step 704 of method 700 involves instructing the user to heat the refill wax. Step 704 may involve instructing the user to heat the refill wax by using a microwave or, alternative, step 704 may involve instructing the user to heat the refill wax by using a standard oven set to a relatively low temperature.

Step 705 of method 700 involves instructing the user to pour the heated refill wax into the candle vessel. Step 705 may alternatively include instructing the user to allow the heated refill wax to at least partially cool and/or to use a stir stick to stir the heated refill wax.

Step 706 of method 700 involves instructing the user to allow the refill wax to sit, set, and cure within the candle vessel before burning the newly formed candle.

And step 707 of method 700 involves instructing the user to trim one or more of the wicks to a useable length. Preferably, users are instructed to trim the one or more wicks to a length of ¼ inch before burning the newly formed candle.

It should be noted that the above described steps of method 700 may be alternatively described as being carried out directly by a user and thus the steps carried out directly by a user is intended to be included in this specification.

While certain embodiments of the present invention have been shown and described, it is to be understood that the present invention is subject to many modifications and changes without departing from the spirit and scope of the invention presented herein. Furthermore, while the present invention has been illustrated and described herein in terms of a preferred embodiment and several alternatives, it is to be understood that the apparatus and/or methods described herein can have a multitude of additional uses and applications. Accordingly, the invention should not be limited to just the description and various drawing figures contained in this specification that merely illustrate a preferred embodiment and application of the principles of the invention. It should be noted that terms of orientation, such as horizontal and vertical and up and down, and direction such as top, bottom, front, rear, etc. as used herein are used to distinguish elements from one another within exemplary embodiments and should therefore not be taken as limiting the scope of the present invention to any specific orientation. Moreover, the use of the terms first, second, etc. do not denote any order or importance, but rather are used to distinguish one element from another. Furthermore, the use of terms a, an, etc. do not denote a limitation of quantity, but rather denote the presence of at least one of the referenced item. Therefore, the detailed description and accompanying drawings are not to be taken in a limiting sense, but rather to enable the present invention.

What is claimed is:

1. A candle making kit apparatus, comprising:
a wax assembly including a refill wax stored in a recyclable container; and
a materials assembly including one or more materials for use with the refill wax;
wherein the recyclable container is heated so that the refill wax may be poured into a candle vessel and combined with one or more materials from the materials assembly to form a candle.

2. The candle making kit apparatus as recited in claim 1, wherein the recyclable container is formed of a microwave-safe material and includes a removable lid.

3. The candle making kit apparatus as recited in claim 1, wherein the material assembly is stored in a materials bag that is recyclable.

4. The candle making kit apparatus as recited in claim 1, wherein the one or more materials include one or more wick assemblies, a stir stick, and a set of instructions for instructing a user to make a candle in a candle vessel using the wax assembly and one or more materials from the materials assembly.

5. The candle making kit apparatus as recited in claim 1, wherein the one or more materials include one or more wick assemblies and wherein each of the one or more wick assemblies includes a wick anchored in a wick adhesive.

6. The candle making kit apparatus as recited in claim 5, wherein each of the wick adhesives includes a wick adhesive cover which may be removed to reveal an surface that adheres to the candle vessel.

7. The candle making kit apparatus as recited in claim 5, wherein each of the wick adhesives is a flat surface for receiving a binding substance to adhere the flat surface to the candle vessel.

8. The candle making kit apparatus as recited in claim 1, wherein the one or more materials includes a first wick assembly having a first wick anchored to a first wick adhesive, a second wick assembly having a second wick anchored to a second wick adhesive, and a third wick assembly having a third wick anchored to a third wick adhesive.

9. The candle making kit apparatus as recited in claim 1, wherein the refill wax is new wax being pouring into a new candle vessel.

10. The candle making kit apparatus as recited in claim 1, wherein the candle vessel is a used candle vessel that previously held different wax than the refill wax.

11. A method for facilitating the use of a candle vessel, the method comprising the steps of:
providing a candle making kit apparatus including a wax assembly having a refill wax stored in a recyclable container and a materials assembly having one or more materials for use with the refill wax and instructions for instructing a user;
instructing the user to prepare a candle vessel to receive refill wax from the wax assembly;
instructing the user to heat the refill wax;
instructing the user to pour the refill wax into the candle vessel;
instructing the user to allow the refill wax to sit, set, and cure before burning.

12. The method for facilitating the use of a candle vessel as recited in claim 11, wherein the one or more materials includes one or more wick assemblies and wherein the method further comprises the steps of:
instructing the user to set one or more wicks assemblies within the candle vessel, including removing one or more adhesive covers from the one or more wick assemblies and attaching the one or more wick assemblies to the candle vessel via the one or more wick adhesives; and
instructing the user to trim one or more wicks of the one or more wick assemblies, after the refill wax has sat, set, and cured.

13. The method for facilitating the use of a candle vessel as recited in claim 11, wherein the step of instructing the user to heat the refill wax involves instructing the user to heat the refill wax in a microwave and wherein the recyclable container is microwave safe.

14. The method for facilitating the use of a candle vessel as recited in claim 11, wherein the step of instructing the user to heat the refill wax involves instructing the user to heat the refill wax in a low heat oven.

15. The method for facilitating the use of a candle vessel as recited in claim 11, wherein the materials assembly includes a stir stick and wherein the step of instructing the user to heat the refill wax involves instructing the user to stir the refill wax when heated.

16. The method for facilitating the use of a candle vessel as recited in claim 15, wherein the materials assembly further includes a one or more additives that may be advantageously combined with the refill wax and wherein the step of instructing the user to heat the refill wax involves instructing the user to add the additives to the heated wax with the stir stick.
